(19) United States
(12) Patent Application Publication
(10) Pub. No.: US 2025/0252029 A1
(43) Pub. Date: Aug. 7, 2025

(54) LOW TEMPERATURE MONITORING AND AUTOMATIC RESTART SYSTEM AND METHOD

(71) Applicant: IBASE TECHNOLOGY INC., TAIPEI (TW)

(72) Inventors: Albert Lee, TAIPEI (TW); YU-CHI HUANG, TAIPEI (TW)

(21) Appl. No.: 19/002,886

(22) Filed: Dec. 27, 2024

(30) Foreign Application Priority Data
Feb. 7, 2024 (TW) 113105126

(51) Int. Cl. G06F 11/30; G06F 11/14

(52) U.S. Cl. CPC G06F 11/3058; G06F 11/1438

(57) ABSTRACT

Low temperature monitoring and automatic restart system and method are disclosed. The system includes a processing module, being for performing an internal operation; a detection module, electrically connected to the processing module and a host, for detecting a status of the host and an ambient temperature; and a restart module, electrically connected to the processing module, the detection module and the host, and being used to send a restart signal to the host. In this way, through a low temperature monitoring mechanism and related hardware circuits, it is ensured that the computer can be restarted and enter the operating system for normal operation.

### PRIOR ART

Low temperature monitoring technology is one of the components of automatic monitoring. Generally speaking, most industrial computers still need to operate normally even in harsh environments; especially in low-temperature environments, peripheral components such as hard drives, memories, or chipsets are subjected to severe tests. As long as any one of these components fails to operate normally, the entire industrial computer system will be in a non-working state until the user discovers and troubleshoots it. If it is in an unmanned environment, it can only wait for the temperature to return to a reasonable working range. This situation does not meet users' expectations for industrial computers.

### BACKGROUND OF THE INVENTION

The present invention relates to the technical field of low-temperature monitoring and automatic restart, in particular to a low temperature monitoring and automatic restart system and method thereof that uses hardware to monitor the status of a computer that requires maintenance to ensure that it can enter the operating system to complete the work.

### SUMMARY OF THE INVENTION

A primary objective of the present invention is to provide a low temperature monitoring and automatic restart system and method thereof. Through the low temperature monitoring mechanism and related hardware circuits, it is ensured that the computer can be restarted and enter the operating system for normal operation.

In order to achieve the aforementioned objective, the present invention provides a low temperature monitoring and automatic restart system. The low temperature monitoring and automatic restart system includes a processing module, configured to perform an internal operation; a detection module, electrically connected to the processing module and a host, and configured to detect a state of the host and an ambient temperature.; and a restart module, electrically connected to the processing module, the detection module and the host, and configured to send a restart signal to the host.

In some embodiments, when the detection module detects that the status of the host is power-on, the detection module starts to detect the ambient temperature.

In some embodiments, when the ambient temperature is lower than a threshold value, the processing module starts a countdown of a predetermined time.

In some embodiments, when the countdown reaches zero and the detection module has not received a normal operation signal sent by the host, the processing module notifies the restart module to send a restart signal to the host, causing the host to perform a restart operation and count down the predetermined time again until the detection module receives the normal operation signal sent by the host.

In some embodiments, the threshold value is −5° C., and the predetermined time is 120 seconds.

The present invention further provides a low temperature monitoring and automatic restart method. The low temperature monitoring and automatic restart method includes detecting whether a host is power-on, if yes, proceed to next step, if not, continue detecting; detecting whether an ambient temperature is lower than a threshold value, if yes, proceed to next step, if not, end detecting; starting a countdown to a predetermined time; waiting for the countdown to reach zero; detecting whether a normal working signal is received; if yes, the host works normally and ends operation; and if not, the host performs a restart operation.

In some embodiments, in the step of detecting whether the host is power-on, when a status of the host which is detected is power-on, the ambient temperature is started to be detected.

In some embodiments, the threshold value is −5° C., and the predetermined time is 120 seconds.

In some embodiments, after the host performs the restart operation, return to the step of starting the countdown of the predetermined time until the normal operation signal is received.

In some embodiments, when the countdown reaches zero and the normal operation signal has not been received, a restart signal is sent to the host to perform the restart operation on the host.

In order to make the above objectives, features and advantages of the present invention more obvious and understandable, the specific embodiments listed in the drawings are described in detail below.

### BRIEF DESCRIPTION OF DRAWINGS

Aspects of the present invention are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 is a block diagram of a low temperature monitoring and automatic restart system according to the present invention.

FIG. 2 is a flow chart of a low temperature monitoring and automatic restart method according to the present invention.

### DETAILED DESCRIPTION OF THE INVENTION

It will be appreciated that, although specific embodiments of the present invention are described herein for purposes of illustration, various modifications may be made without departing from the spirit and scope of the present invention.

In the following description, certain specific details are set forth in order to provide a thorough understanding of various aspects of the disclosed subject matter. However, the disclosed subject matter may be practiced without these specific details. In some instances, well-known structures and methods of power delivery comprising embodiments of the subject matter disclosed herein have not been described in detail to avoid obscuring the descriptions of other aspects of the present invention.

Unless the context requires otherwise, throughout the specification and claims that follow, the word “comprise,” “have,” “include,” and variations thereof, such as “comprises,” “comprising,” “having,” “including” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present invention.

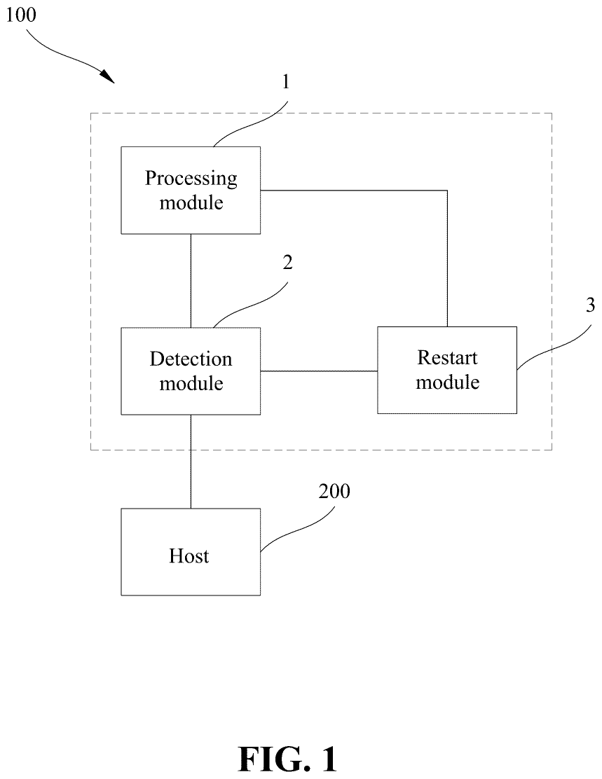

FIG. 1 is a block diagram of a low temperature monitoring and automatic restart system according to the present invention.

Please refer to FIG. 1, the low temperature monitoring and automatic restart system 100 of the present invention includes a processing module 1, a detection module 2 and a restart module 3.

The processing module 1 is configured to perform an internal operation. In some embodiments, the processing module 1 is a central processing unit (CPU), but it is not limited thereto.

The detection module 2 is electrically connected to the processing module 1 and a host 200, and is configured to detect a state of the host 200 and an ambient temperature. In some embodiments, the host 200 may be an industrial computer, but it is not limited thereto. When the detection module 2 detects that the status of the host 200 is “power-on”, the detection module 2 starts to detect the ambient temperature of the host 200. When the ambient temperature is lower than a threshold value, the processing module 1 starts a countdown for a predetermined time. In some embodiments, the threshold value is −5° C. and the predetermined time is 120 seconds, but it is not limited thereto.

The restart module 3 is electrically connected to the processing module 1, the detection module 2 and the host 200, and is configured to send a restart signal to the host 200. When the countdown reaches zero and the detection module 2 has not yet received a normal operation signal sent by the host 200, the processing module 1 notifies the restart module 3 to send the restart signal to the host 200, causing the host 200 to perform a restart operation and count down the predetermined time again until the detection module 2 receives the normal operation signal sent by the host 200.

The detailed operation content of the low temperature monitoring and automatic restart system 100 of the present invention will be described in the following low temperature monitoring and automatic restart method S100.

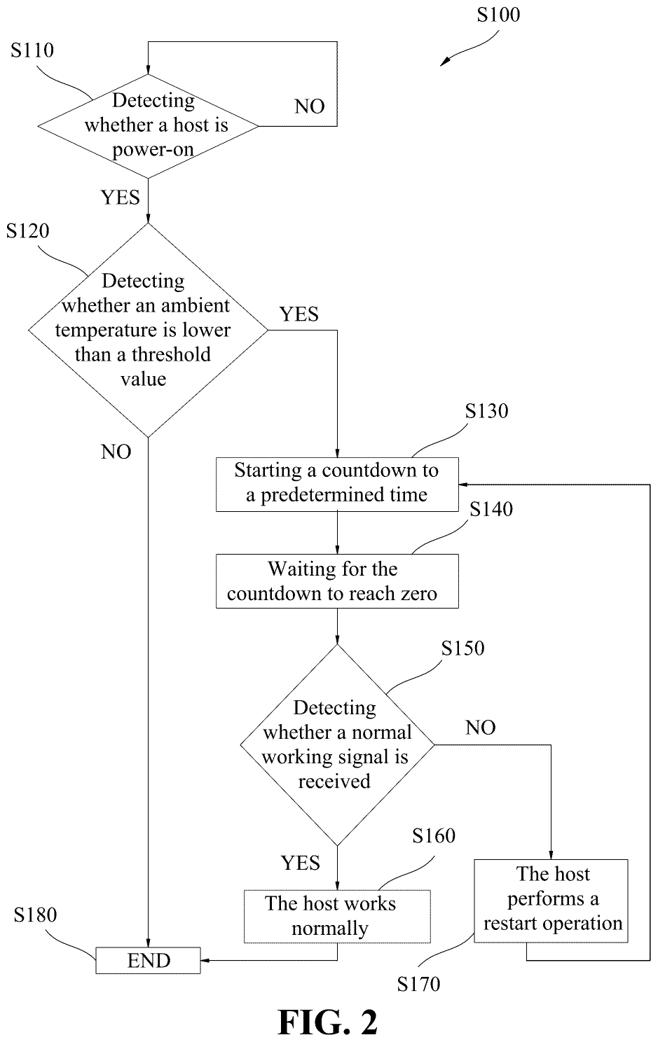

FIG. 2 is a flow chart of a low temperature monitoring and automatic restart mrthod according to the present invention.

Please refer to FIG. 2, combined with FIG. 1, the low temperature monitoring and automatic restart method S100 of the present invention includes the following steps.

Step S110: detecting whether a host (i.e., host 200) is power-on, if yes, proceed to next step (i.e., step S120), if not, continue detecting (i.e., step 110).

Step S120: detecting whether an ambient temperature is lower than a threshold value, if yes, proceed to next step (i.e., step S130), if not, end detecting (i.e., step S180).

Step S130: starting a countdown to a predetermined time.

Step S140: waiting for the countdown to reach zero.

Step S150: detecting whether a normal working signal is received.

Step S160: if yes, the host (i.e., host 200) works normally and ends operation (i.e., step S180).

Step S170: if not, the host (i.e., host 200) performs a restart operation, and then return to step S130 until the normal operation signal is received.

Step S180: ending operation.

In the step (i.e., step S110) of detecting whether the host is power-on, when a status of the host which is detected is power-on, the ambient temperature is started to be detected.

In some embodiments, in step S120, the threshold value is −5° C., but it is not limited thereto.

In some embodiments, in step S130, the predetermined time is 120 seconds, but it is not limited thereto.

Steps S110 to S190 of the low temperature monitoring and automatic restart method S100 in FIG. 2 can be implemented by using the processing module 1, the detection module 2 and the restart module 3 of the low temperature monitoring and automatic restart system 100 in FIG. 1.

In summary, the low-temperature monitoring and automatic restart system 100 and method S100 of the present invention is ensured that the computer (i.e., the host 200 or the industrial computer) can be restarted and enter the operating system for normal operation through the low temperature monitoring mechanism and related hardware circuits.

The above descriptions are only used to explain the preferred embodiments of the present invention, and are not intended to limit the present invention in any form. Therefore, any modifications or changes made to the present invention under the same inventive spirit should still be included in the scope of protection intended by the present invention.

1. A low temperature monitoring and automatic restart system, comprising:
a processing module, configured to perform an internal operation;
a detection module, electrically connected to the processing module and a host, and configured to detect a state of the host and an ambient temperature; and
a restart module, electrically connected to the processing module, the detection module and the host, and configured to send a restart signal to the host;
wherein when the detection module detects that the status of the host is power-on, the detection module starts to detect the ambient temperature;
wherein when the ambient temperature is lower than a threshold value, the processing module starts a countdown of a predetermined time; and
wherein when the countdown reaches zero and the detection module has not received a normal operation signal sent by the host, the processing module notifies the restart module to send a restart signal to the host, causing the host to perform a restart operation and count down the predetermined time again until the detection module receives the normal operation signal sent by the host.

2. The low temperature monitoring and automatic restart system according to claim 1, wherein the threshold value is −5° C., and the predetermined time is 120 seconds.

3. A low temperature monitoring and automatic restart method, comprising:
detecting whether a host is power-on, if yes, proceed to next step, if not, continue detecting;
detecting whether an ambient temperature is lower than a threshold value, if yes, proceed to next step, if not, end detecting;
starting a countdown to a predetermined time;
waiting for the countdown to reach zero;
detecting whether a normal working signal is received;
if yes, the host works normally and ends operation; and
if not, the host performs a restart operation;
wherein in the step of detecting whether the host is power-on, when a status of the host which is detected is power-on, the ambient temperature is started to be detected;
wherein after the host performs the restart operation, return to the step of starting the countdown of the predetermined time until the normal operation signal is received; and
wherein when the countdown reaches zero and the normal operation signal has not been received, a restart signal is sent to the host to perform the restart operation on the host.

4. The low temperature monitoring and automatic restart method according to claim 3, wherein the threshold value is −5° C., and the predetermined time is 120 seconds.
